(19) United States
(12) Patent Application Publication
(10) Pub. No.: US 2011/0003566 A1
(43) Pub. Date: Jan. 6, 2011

(54) RADIO FREQUENCY POWER AMPLIFIER

(75) Inventors: Hirokazu MAKIHARA, Osaka (JP); Kazuki TATEOKA, Kyoto (JP); Masahiko INAMORI, Osaka (JP); Shingo MATSUDA, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/823,415

(22) Filed: Jun. 25, 2010

(30) Foreign Application Priority Data
Jul. 2, 2009 (JP) 2009-158292

(51) Int. Cl. H01Q 11/12

(52) U.S. Cl. 455/127.1

(57) ABSTRACT

An RF power amplifier according to the present invention includes: an RF power amplifying element, a first switch provided in a first transmission path for transmitting a first RF signal output from the RF power amplifying element, a second transmission unit which transmits a second RF signal of higher frequency than the first RF signal output from the RF power amplifying element, and a second second-order harmonic trap circuit connected to an output terminal, and the second transmission unit includes a grounded capacitor, a second transmission path, a Band-I matching circuit, a second switch connected in series to the second transmission path, and the second switch connects the second transmission path to the grounded capacitor when the first RF signal is amplified, and connects the second transmission path to the Band-I matching circuit when the second RF signal is amplified.

### BACKGROUND OF THE INVENTION

(1) Field of the Invention

The present invention relates to a radio frequency (RF) power amplifier used for a mobile communication device and so on.

(2) Description of the Related Art

With recent development in mobile communication systems, there is a growing demand for compatibility with multiple bands and multiple modes in accordance with different mobile communication systems which specify different usable frequency ranges and modulation methods.

Conventionally, in response to the demand for such compatibility with multiple bands and multiple modes, a method conventionally used for the RF power amplifier used in a sending portion of the mobile communication device is to arrange an RF power amplifier corresponding to each frequency band and modulation system to be used, or to provide a module in which plural RF power amplifying elements and a matching circuit are integrated as a package.

However, in these methods, a larger mounting area is required when a larger number of power amplifiers are used, thus causing a problem of difficulty in compatibility with multiple bands and multiple modes.

To solve this problem, a method of preparing plural output matching circuits for one RF power amplifying element and switching the output matching circuits using a switch has been proposed, and further a configuration for downsizing the output matching circuits has been proposed (for example, see Patent Reference 1: Japanese Unexamined Patent Application Publication No. 2005-210580).

FIG. 10 shows a conventional example disclosed in Patent Reference 1.

In the figure, a path leading from an output terminal 4 of an RF power amplifying element 1 to a first output port 5 is assumed to be a first output path, and a path leading from the output terminal 4 to a second output port 10 is assumed to be a second output path.

The RF power amplifier shown in FIG. 10 is connected, in the second output path, between the first output path that is an output path for a first frequency signal and a ground, and includes a stripline 7 which suppresses a harmonic component of the first frequency signal. In addition, a first switch element is provided in the first path and a second switch element 12 is provided between the second output path and a ground, and the first frequency signal and the second frequency signal are switched by switching opening and closing of these switch elements. Since this allows separating the second frequency signal with the stripline 7 which suppresses the harmonic component of the first frequency signal, it is possible to suppress increase in the number of circuit elements, and thus downsizing of the RF power amplifier compatible with multiple bands is realized.

### SUMMARY OF THE INVENTION

However, the conventional configuration shown in FIG. 10 has a problem of insufficient suppression of a power leakage into the second output port due to a parasitic inductance component of the second switch element when operating at the first frequency signal.

In addition, in the conventional configuration shown in FIG. 10, a second-order harmonic trap circuit for the second frequency signal includes a stripline 7, a stripline 11, and a capacitor 16. However, in practice, the stripline 7 is designed to resonate with a second-order harmonic signal of the first frequency signal; thus, in order to cause the stripline 7 to resonate with the second-order harmonic of the second signal frequency, which corresponds to the second-order harmonic of the first signal frequency, it is necessary to use a stripline having a length almost half the length of the stripline 7. Thus, in practice, it is impossible to create the second-order harmonic trap circuit of the second signal frequency, using a resonance circuit including the striplines 7 and 11 and the capacitor 16.

In addition, in the conventional configuration, the second-order harmonic trap circuit for the second frequency signal includes the switch element 12; thus, when operating at the second frequency signal, a significant power loss is generated in a load matching circuit that is a circuit from the output terminal 4 to the first output port 5 and the second output port 10. This causes a problem of decreasing efficiency of the power amplifier.

The object of the present invention is to solve these problems and to provide an RF power amplifier which ensures high isolation between output terminals and achieves high efficiency.

A radio frequency power amplifier according to an aspect of the present invention includes: an amplifying element which amplifies a first radio frequency signal and a second radio frequency signal having a frequency higher than a frequency of the first radio frequency signal; a first transmission unit which transmits the first radio frequency signal output by the amplifying element; a second transmission unit which transmits the second radio frequency signal output by the amplifying element; and a second radio frequency signal trap circuit which is connected to an output terminal of the amplifying element and suppresses a harmonic signal of the second radio frequency signal amplified by the amplifying element, and the first transmission unit includes: a first transmission path through which the first radio frequency signal output by the amplifying element is transmitted; and a switch element which is provided in the first transmission path, and which turns on when the amplifying element amplifies the first radio frequency signal, and turns off when the amplifying element amplifies the second radio frequency signal, and the second transmission unit includes: an impedance circuit which suppresses a harmonic signal of the first radio frequency signal; a second transmission path through which the first radio frequency signal and the second radio frequency signal output by the amplifying element are transmitted; a third transmission path through which the second radio frequency signal is transmitted to an output terminal of the second transmission unit; and a switch circuit which connects the second transmission path and the impedance circuit in series when the amplifying element amplifies the first radio frequency signal, and which connects the second transmission path and the third transmission path in series when the amplifying element amplifies the second radio frequency signal.

With this, when the amplifying element amplifies the second RF signal, the second RF signal is transmitted only to the third transmission path among the impedance circuit and the third transmission path, and the second RF signal is not transmitted to the output terminal of the first transmission unit on the output side of the first transmission path. On the other hand, when the amplifying element amplifies the first RF signal, the first RF signal is not to transmitted to the output terminal of the second transmission unit, and the first RF signal is transmitted to the output terminal of the first transmission unit. Thus, it is possible to sufficiently secure isolation between the output terminal of the first transmission unit and the output terminal of the second transmission unit.

In addition, the second RF signal trap circuit is connected to the output terminal of the amplifying element, thereby reducing the loss in the load matching circuit of the amplifying element when the amplifying element amplifies the second RF signal. As a result, the efficiency of the RF power amplifier is enhanced.

In addition, the second transmission path and the impedance circuit may function as a first radio frequency signal trap circuit which suppresses the harmonic signal of the first radio frequency signal via the switch circuit, when the switch circuit connects the second transmission path and the impedance circuit.

With this, it is possible to suppress the harmonic of the first RF signal to be transmitted through the first transmission path. As a result, it is possible to suppress unnecessary radiation from the RF power amplifier.

In addition, the second transmission path may include a second radio frequency transmission line having one end connected to the output terminal of the amplifying element and the other end electrically connected to the switch circuit, and the second transmission unit may further include a capacitor having one end electrically connected to the second radio frequency transmission line and the other end grounded.

With this, since the capacitor is located in front of the switch circuit, with respect to the output terminal of the amplifying element, it can be considered that part of the synthesized capacitance of the first RF signal trap circuit is grounded without involving the switch circuit. Thus, it is possible to reduce the loss generated in the first RF signal trap circuit as compared to the case of not including the capacitor.

In addition, the capacitance value of the first RF signal trap circuit is determined by the synthesized capacitance value of the capacitor and the impedance circuit; thus, it is possible to reduce the capacitance value of the impedance circuit with the configuration as above. Thus, it is possible to downsize the impedance circuit.

In addition, the first transmission path may include a first radio frequency transmission line having one end connected to an output terminal of the amplifying element and the other end electrically connected to the switch circuit, and an inductance component of the first transmission path may be larger than inductance components of the second transmission path and the capacitor.

With this, it is possible to share part of the first RF signal trap circuit, and the transmission unit for the second RF signal which is the second and the third transmission paths, thus allowing downsizing of the load matching circuit.

In addition, a resonance frequency of the first radio frequency signal trap circuit may be within a frequency range that is double a frequency range of the first radio frequency signal, and a resonance frequency of the second radio frequency signal trap circuit may be within a frequency range that is double a frequency range of the second radio frequency signal.

With this, it is possible to effectively suppress the harmonic of the first RF signal and the second RF signal.

In addition, a resonance frequency of the impedance circuit may be within a frequency range that is double a frequency range of the first radio frequency signal, and a resonance frequency of the second radio frequency signal trap circuit may be within a frequency range that is double a frequency range of the second radio frequency signal.

In addition, each of frequency ranges of the first radio frequency signal and the second radio frequency signal may include a frequency band of at least one communication system.

With this, it is possible to achieve compatibility with multiple bands and multiple modes.

According to the present invention, it is possible to provide an RF power amplifier which secures high isolation between output terminals and achieves high efficiency.

### FURTHER INFORMATION ABOUT TECHNICAL BACKGROUND TO THIS APPLICATION

The disclosure of Japanese Patent Application No. 2009-158292 filed on Jul. 2, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a schematic view of a circuit configuration of an RF power amplifier according to a first embodiment;

FIG. 2 is block diagram showing an example configuration, from an output terminal to an antenna of a common RF power amplifier;

FIG. 3 is a diagram showing a schematic view of a circuit configuration extended to be multiband and multimode;

FIG. 4 is a diagram showing a schematic view of a circuit configuration of an RF power amplifier according to a second embodiment;

FIG. 5A is a diagram showing a specific configuration used for a simulation;

FIG. 5B is a diagram showing a simulation condition;

FIG. 6A is a graph showing an insertion loss in a load matching circuit when operating at Band-V;

FIG. 6B is a graph showing an insertion loss in a load matching circuit when operating at Band-V;

FIG. 6C is a graph showing an insertion loss in a load matching circuit when operating at Band-IX;

FIG. 7A is a graph showing a gain in each amplifier output terminal when operating at Band-V;

FIG. 7B is a graph showing a gain in each amplifier output terminal when operating at Band-I;

FIG. 7C is a graph showing a gain in each amplifier output terminal when operating at Band-IX;

FIG. 8 is a graph showing a gain in each output terminal of a circuit corresponding to a conventional technique;

FIG. 9A is an example of a usable frequency range indicated by each communication standard;

FIG. 9B is an example of a usable frequency range indicated by each communication standard; and

FIG. 10 is a diagram showing an example disclosed in Patent Reference 1.

### DESCRIPTION OF THE PREFERRED EMBODIMENTS

Hereinafter, examples related to embodiments according to the present invention will be described with reference to the drawings. Note that in the drawings, an element having substantially the same configuration, operation, and advantageous effect is assigned with the same numerical reference. In addition, all the values described hereafter are given as mere examples to specifically describe the present invention, and such values given as examples are not to limit the present invention. Furthermore, the connection relationship between constituent elements is given as a mere example to specifically describe the present invention, and the connection relationship which realizes the function according to the present invention is not limited to such a connection relationship.

### First Embodiment

A radio frequency (RF) power amplifier according to the present embodiment includes: an amplifying element which amplifies a first radio frequency signal and a second radio frequency signal having a frequency higher than a frequency of the first radio frequency signal; a first transmission unit which transmits the first radio frequency signal output by the amplifying element; a second transmission unit which transmits the second radio frequency signal output by the amplifying element; and a second radio frequency signal trap circuit which is connected to an output terminal of the amplifying element and suppresses a harmonic signal of the second radio frequency signal amplified by the amplifying element, and the first transmission unit includes: a first transmission path through which the first radio frequency signal output by the amplifying element is transmitted; and a switch element which is provided in the first transmission path, and which turns on when the amplifying element amplifies the first radio frequency signal, and turns off when the amplifying element amplifies the second radio frequency signal, and the second transmission unit includes: an impedance circuit which suppresses a harmonic signal of the first radio frequency signal; a second transmission path through which the first radio frequency signal and the second radio frequency signal output by the amplifying element are transmitted; a third transmission path through which the second radio frequency signal is transmitted to an output terminal of the second transmission unit; and a switch circuit which connects the second transmission path and the impedance circuit in series when the amplifying element amplifies the first radio frequency signal, and which connects the second transmission path and the third transmission path in series when the amplifying element amplifies the second radio frequency signal.

With this, when the amplifying element amplifies the second RF signal, the second RF signal is transmitted only to the third transmission path among the impedance circuit and the third transmission path, and the second RF signal is not transmitted to the output terminal of the first transmission unit on the output side of the first transmission path. On the other hand, when the amplifying element amplifies the first RF signal, the first RF signal is not transmitted to the output terminal of the second transmission unit, and the first RF signal is transmitted to the output terminal of the first transmission unit. Thus, it is possible to sufficiently secure isolation between the output terminal of the first transmission unit and the output terminal of the second transmission unit.

In addition, the second RF signal trap circuit is connected to the output terminal of the amplifying element, thereby reducing the loss in the load matching circuit of the amplifying element when the amplifying element amplifies the second RF signal. As a result, the efficiency of the RF power amplifier is enhanced.

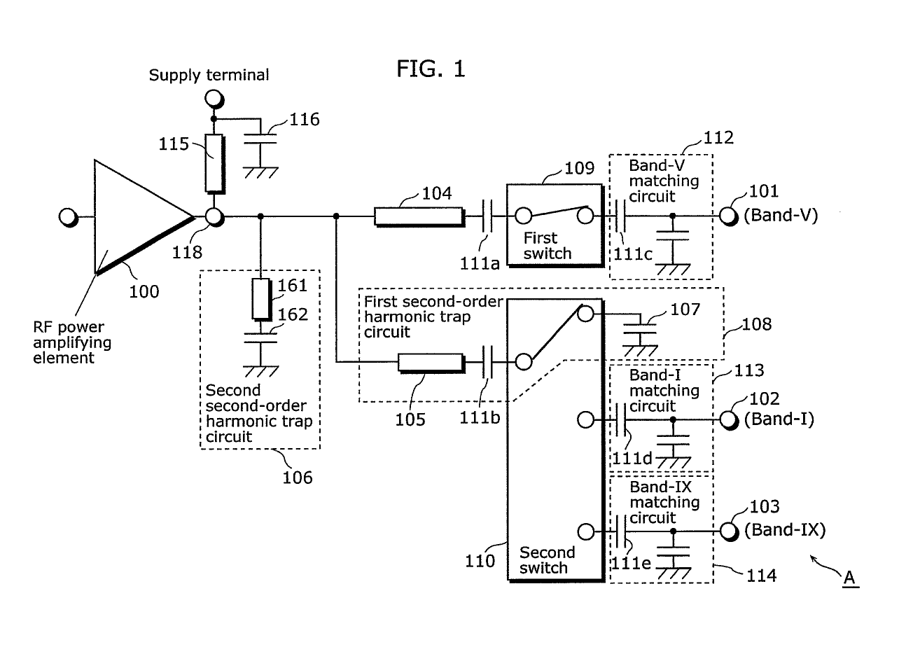

FIG. 1 is a diagram showing a schematic view of a circuit configuration of an RF power amplifier according to the first embodiment. Note that the present embodiment is described with reference to a configuration of an RF power amplifier compatible with three bands, which uses: a signal of Band-V (824 MHz to 849 MHz) in accordance with the Universal Mobile Telecommunications System (UMTS) as a first frequency range; and signals of Band-I (1920 MHz to 1980 MHz) and of Band-IX (1749.9 MHz to 1784.9 MHz) in accordance with the UMTS as a second frequency range.

The RF power amplifier A shown in FIG. 1 includes: an RF power amplifying element 100, a Band-V amplifier output terminal 101, a Band-I amplifier output terminal 102, a Band-IX amplifier output terminal 103, transmission lines 104 and 105, a second second-order harmonic trap circuit 106, a grounded capacitor 107, a first switch 109, a second switch 110, DC-cutting capacitors 111a to e, a Band-V matching circuit 112, a Band-I matching circuit 113, and a Band-IX matching circuit 114. Here, when the grounded capacitor 107 and the transmission line 105 are electrically connected by the second switch 110, the transmission line 105 and the grounded capacitor 107 function, via the second switch 110, as a first second-order harmonic trap circuit 108. Note that the first second-order harmonic trap circuit 108 corresponds to the first RF signal trap circuit according to the present invention, which suppresses the second-order harmonic of a fundamental wave of the first RF signal.

Note that the transmission line is not essential. In addition, in the description hereafter, a load matching circuit corresponds to a portion from an output terminal 118 of the RF power amplifying element 100 to an amplifier output terminal in each band (Band-V amplifier output terminal 101, Band-I amplifier output terminal 102, and Band-IX amplifier output terminal 103). In addition, each of the DC-cutting capacitors 111a to e is simply described as a DC-cutting capacitor when not particularly distinguished from each other. In addition, the transmission line 104, a DC-cutting capacitor 111a, and the Band-V matching circuit 112 correspond to a first transmission path according to the present invention. In addition, the transmission line 104, the first switch 109, DC-cutting capacitors 111a and 111c, and the Band-V matching circuit 112 function as the first transmission unit. In addition, the transmission line 105 and a DC-cutting capacitor 111b correspond to the second transmission path according to the present invention. In addition, the Band-I matching circuit 113 and the Band-IX matching circuit 114 each correspond to the third transmission path according to the present invention. In addition, the grounded capacitor 107 corresponds to an impedance circuit according to the present invention. In addition, the transmission line 105, the DC-cutting capacitor 111b, the second switch 110, the grounded capacitor 107, the Band-I matching circuit 113, and the Band-IX matching circuit 114 correspond to the second transmission unit according to the present invention.

The RF power amplifying element 100 is the amplifying element according to the present invention, and is, for example, a transistor which amplifies, according to a voltage supply, the first RF signal that is an input signal of the first RF band and the second RF signal that is an input signal of the second RF band. Furthermore, the RF power amplifying element 100 outputs the amplified first RF signal and second RF signal to the transmission line 104, the transmission line 105, and the second second-order harmonic trap circuit 106 via the output terminal. To the RF power amplifying element 100, a supply voltage supplied from the supply terminal is applied via the transmission line 115 for biasing. Note that the transmission line 115 is connected to the grounded capacitor 116 for bypassing.

The transmission line 104 is, for example, a microstrip line, having one end connected to the output terminal 118 of the RF power amplifying element 100 and the other end connected to an end of the DC-cutting capacitor 111a.

The transmission line 105 is the second RF according to the present invention, and is, for example, a microstrip line, having one end connected to the output terminal 118 of the RF power amplifying element 100 and the other end connected to one end of the DC-cutting capacitor 111b. The transmission line 105 and the DC-cutting capacitor 111b function as part of the first second-order harmonic trap circuit 108.

The second second-order harmonic trap circuit 106, which is a trap circuit for the second RF signal according to the present invention, suppresses the second-order harmonic of a fundamental wave of the second RF signal; specifically, the second second-order harmonic trap circuit 106 includes, a transmission line 161 having one end connected to the output terminal 118 of the RF power amplifying element 100, and a grounded capacitor 162 having one end connected to the other end of the transmission line 161 and the other end grounded. A resonance frequency of the second second-order harmonic trap circuit n 106 is set to a value which can sufficiently suppress a second-order harmonic signal of the second frequency range at which the RF power amplifier A is used. In the present embodiment, the resonance frequency is set to a value which can sufficiently suppress signals of the second-order harmonic frequency of Band-I (3840 MHz to 3960 MHz) and of the second-order harmonic frequency of Band-IX (3499.8 MHz to 3569.8 MHz).

The grounded capacitor 107 functions as another part of the first second-order harmonic trap circuit 108 according to the present invention. Specifically, the grounded capacitor 107 has one end connected to one of the switch output terminals of the second switch 110 and the other end grounded. It is possible to set an impedance of the impedance circuit according to the capacitance of the grounded capacitor 107.

The first second-order harmonic trap circuit 108 suppresses the second-order harmonic of the first RF signal amplified by the RF power amplifying element 100. Specifically, the resonance frequency of the first second-order harmonic trap circuit 108 is set to a value which can sufficiently suppress the second-order harmonic signal of the first frequency band that is used. In the present embodiment, the resonance frequency is set to a value which can sufficiently suppress a signal of the second-order harmonic frequency of Band-V (1648 MHz to 1698 MHz).

The first switch 109, which is a switch element according to the present invention, turns on to electrically connect the transmission line 104 and the Band-V matching circuit 112 in series when the RF power amplifying element 100 amplifies the RF signal, and turns off when the RF power amplifying element 100 amplifies the second RF signal. Specifically, the first switch 109 has a switch input terminal connected to the other end of the DC-cutting capacitor 111a, and a is switch output terminal connected to one end of a DC-cutting capacitor 111c.

The second switch 110 is the switch circuit according to the present invention, having one switch input terminal and three switch output terminals: the switch input terminal is connected to the other end of the DC-cutting capacitor 111b; one of the three switch output terminals is connected to one end of the grounded capacitor 107; another one of the three switch output terminals is connected to the Band-I matching circuit 113; and the remaining one of the three switch output terminals is connected to the Band-IX matching circuit 114. The second switch 110 selectively connects the switch input terminal to one of the three switch output terminals according to the frequency amplified by the RF power amplifying element 100.

Specifically, when the RF power amplifying element 100 amplifies the first RF signal, the second switch 110 electrically connects the transmission line 105 and the grounded capacitor 107 in series by selectively connecting the switch output terminal connected to the grounded capacitor 107, to the switch input terminal. In addition, when the RF power amplifying element 100 amplifies the second RF signal, the second switch 110 selects, according to the frequency band to be used, one of the switch output terminals that is connected to the Band-I matching circuit 113 and another one of the switch output terminal that is connected to the Band-IX matching circuit 114, and connects the selected switch output terminal to the switch input terminal. Specifically, when Band-I is the frequency band to be used, the second switch 110 electrically connects the transmission line 105 and the Band-I matching circuit 113 in series by selectively connecting the switch output terminal connected to the Band-I matching circuit 113, to the switch input terminal. On the other hand, when Band-IX is the frequency band to be used, the second switch 110 electrically connects the transmission line 105 and the Band-IX matching circuit 114 in series by selectively connecting the switch output terminal connected to the Band-IX matching circuit 114, to the switch input terminal.

Each of the DC-cutting capacitors 111a to e removes a direct current (DC) component after a point at which each of the DC-cutting capacitors 111a to e is inserted, in a transmission direction in which the RF signal is transmitted through the inserted path.

The Band-V matching circuit 112 includes the DC-cutting capacitor 111c having one end connected to one of the switch output terminals of the first switch 109 and the other end connected to the Band-V amplifier output terminal 101, and a grounded capacitor having one end connected to the other end of the DC-cutting capacitor 111c and the other end grounded. With this, the RF power amplifier A operating at Band-V matches, to 50Ω, for example, the RF signal output from the RF power amplifying element 100, and outputs the matched RF signal to the Band-V amplifier output terminal 101. Note that the Band-I matching circuit 113 and the Band-IX matching circuit 144 have the same configuration and are connected to different switch output terminals of the second switch 110.

The following will describe an operation, in each band, of the RF power amplifier A having a configuration as above.

First, the case where the RF power amplifier A operates at Band-I of the second frequency range is described.

When the RF power amplifier A operates at Band-I of the second frequency range, the first switch 109 turns off, so that the switch input terminal and the switch output terminal are disconnected. On the other hand, the second switch 110 connects the switch input terminal and the switch output terminal connected to the Band-I matching circuit 113.

The RF signal output from the output terminal 118 of the RF power amplifying element 100, with the second-order harmonic of the second frequency range sufficiently suppressed by the second second-order harmonic trap circuit 106, is transmitted via the second switch 110 and the Band-I matching circuit 113, to be output from the Band-I amplifier output terminal 102. At this time, the impedance of the output terminal 118 of the RF power amplifying element 100 at fundamental frequency of Band-I is more or less several ohms. However, the impedance is matched to the load impedance of the Band-I amplifier output terminal 102 (generally, 50Ω is used for an RF wireless transmission system) mainly by the transmission line 105 and the Band-I matching circuit 113. At this time, the matching of impedance may be adjusted by setting the capacitance value of the DC-cutting capacitor 111d to an appropriate value.

The output terminal 118 of the RF power amplifying element 100 is also connected to the transmission line 104, but the transmission line 104 functions as an open stub because the first switch 109 is off. The resonance frequency at this open stub needs to be set sufficiently higher than the frequency range of Band-I so as not to influence the matching of the fundamental frequency of Band-I.

Thus, when the RF power amplifier A operates at Band-I, the first switch 109 is off, and the switch input terminal is disconnected from the switch output terminal, so that the RF signal leaking into the Band-V amplifier output terminal 101 can be sufficiently suppressed.

In addition, the second switch 110 connects the switch input terminal and the switch output terminal connected to the Band-I matching circuit 113, and the switch output terminal connected to the Band-IX matching circuit 114 is disconnected from the switch input terminal, so that the RF signal leaking into the Band-IX amplifier output terminal 103 can be sufficiently suppressed.

Next, the case where the RF power amplifier A operates at Band-IX is described.

When the RF power amplifier A operates at Band-IX of the second frequency range, the first switch 109 turns off, so that the switch input terminal is disconnected from the switch output terminal. On the other hand, the second switch 110 connects the switch input terminal and the switch output terminal connected to the Band-IX matching circuit 114.

The RF signal output from the output terminal 118 of the RF power amplifying element 100, with the second-order harmonic of the second frequency range sufficiently suppressed by the second second-order harmonic trap circuit 106, is transmitted via the second switch 110 and the Band-IX matching circuit 114, to be output from the Band-IX amplifier output terminal 103. The impedance of the output terminal 118 of the RF power amplifying element 100, which is more or less several ohms at fundamental frequency of Band-IX, is matched to the load impedance of the Band-IX amplifier output terminal 103 (generally, 50Ω is used for the RF wireless transmission system) mainly by the transmission line 105 and the Band-IX matching circuit 114. At this time, the matching of impedance may be adjusted by setting the capacitance value of a DC-cutting capacitor 111e to an appropriate value.

In addition, the transmission line 104 does not influence the matching of the fundamental frequency of Band-IX as in the case of the RF power amplifier A operating at Band-I.

As described above, when the RF power amplifier A operates at Band-IX, the first switch 109 is off, so that, as in the case of operating at Band-I, the RF signal leaking into the Band-V amplifier output terminal 101 can be sufficiently suppressed.

In addition, the second switch 110 connects the switch input terminal and the switch output terminal connected to the Band-IX matching circuit 114. In other words, the switch output terminal connected to the Band-I matching circuit 113 is disconnected from the switch input terminal, so that the RF signal leaking into the Band-I amplifier output terminal 102 can be sufficiently suppressed.

Next, the case where the RF power amplifier A operates at Band-V is described.

When the RF power amplifier A operates at Band-V that is the first frequency band, the first switch 109 turns on, and the switch input terminal and the switch output terminal are connected.

In addition, in the second switch 110, the switch input terminal and the switch output terminal connected to the grounded capacitor 107 are connected to each other. Accordingly, the transmission line 105 and the grounded capacitor 107 are electrically connected with the second switch 110. Thus, when the transmission line 105 and the grounded capacitor 107 are electrically connected with the second switch 110, the transmission line 105 and the grounded capacitor 107 function, via the second switch 110, as the first second-order harmonic trap circuit 108 which suppresses the second-order harmonic of the first frequency band.

The RF signal output from the output terminal 118 of the RF power amplifying element 100, with the second-order harmonic of the first frequency band sufficiently suppressed by the first second-order harmonic trap circuit 108, is transmitted via the transmission line 104, the first switch 109, and the Band-V matching circuit 112, to be output from the Band-V amplifier output terminal 101. The impedance of the output terminal 118 of the RF power amplifying element 100, which is more or less several ohms at fundamental frequency of Band-V, is matched to the load impedance of the Band-V amplifier output terminal 101 mainly by the transmission line 104 and the Band-V matching circuit 112. At this time, the matching of impedance may be adjusted by setting the capacitance value of the DC-cutting capacitor 111c to an appropriate value.

In addition, the output terminal 118 of the RF power amplifying element 100 is also connected to the second second-order harmonic trap circuit 106, but does not influence the matching of the fundamental frequency of Band-V because the resonance frequency of the second second-order harmonic trap circuit 106 is 3 GHz or higher.

Thus, when the RF power amplifier A operates at Band-V, the second switch 110 connects the switch input terminal and the switch output terminal connected to the grounded capacitor 107, so that the RF signal leaking into the Band-I amplifier output terminal 102 and the Band-IX amplifier output terminal 103 can be sufficiently suppressed.

As described above, in the case of operating at Band-V that is the first frequency band, the RF power amplifier A according to the present embodiment prevents the RF signal amplified by the RF power amplifying element 100 from being transmitted to leak into the Band-I amplifier output terminal 102 and the Band-IX amplifier output terminal 103, by turning on the first switch while connecting, in the second switch 110, the switch input terminal and the switch output terminal connected to the grounded capacitor 107.

On the other hand, when operating at Band-I of the second frequency range, the RF power amplifier A turns off the first switch while connecting, in the second switch 110, the switch input terminal and the switch output terminal connected to the Band-I matching circuit 113. This prevents the RF signal amplified by the RF power amplifying element 100 from being transmitted to leak into the Band-V amplifier output terminal 101 and the Band-IX amplifier output terminal 103. On the other hand, when operating at Band-I of the second frequency range, the RF power amplifier A turns off the first switch and connects, in the second switch 110, the switch input terminal and the switch output terminal connected to the Band-IX matching circuit 114. This prevents the RF signal amplified by the RF power amplifying element 100 from being transmitted to leak into the Band-V amplifier output terminal 101 and the Band-I amplifier output terminal 102.

Thus, the RF power amplifier A according to the present embodiment can sufficiently secure isolation between the respective amplifier output terminals (Band-V amplifier output terminal 101, Band-I amplifier output terminal 102, and Band-IX amplifier output terminal 103).

In addition, the RF power amplifying element 100 and the second second-order harmonic trap circuit 106 are connected without involving the switch element, and the second second-order harmonic trap circuit 106 does not include the switch element, thus making it possible to reduce the loss in the load matching circuit when the RF power amplifier A operates in the second frequency range. As a result, the efficiency of the RF power amplifier A is enhanced.

In addition, in the RF power amplifier A, the transmission line 105, the DC-cutting capacitor 111b, and the grounded capacitor 107 function as the first second-order harmonic trap circuit 108 via the second switch 110, thus allowing suppressing unnecessary radiation generated by the second-order harmonic of the first frequency band being transmitted to the Band-V amplifier output terminal 101.

In addition, the resonance frequency of the first second-order harmonic trap circuit 108 is within the frequency range that is double the first frequency range, and the resonance frequency of the second second-order harmonic trap circuit 106 is within the frequency range that is double the second frequency range. With this, it is possible to effectively suppress the harmonic of the first frequency range when operating in the first frequency range, and the harmonic of the second frequency range when operating in the second frequency range.

In addition, the RF power amplifier A can switch, according to an operating band at which it operates, the output among three amplifier output terminals (Band-V amplifier output terminal 101, Band-I amplifier output terminal 102, and Band-IX amplifier output terminal 103), and is therefore compatible with the three Bands. Furthermore, it is possible to further increase compatibility with multiple bands and multiple modes by increasing the number of the switch output terminals of the first switch 109 and the switch output terminals of the second switch 110.

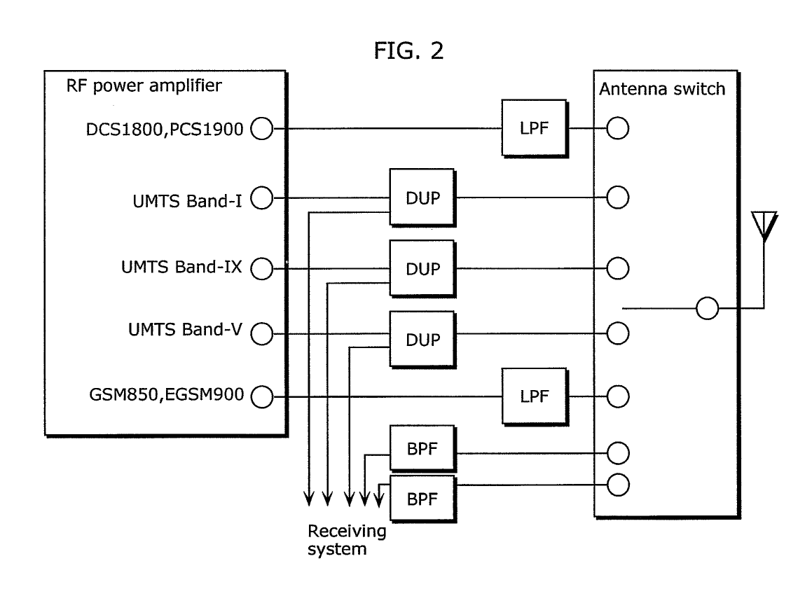

For example, in some communication systems such as UMTS, there is a case where the element connected to the output terminal of the power amplifier differs from band to band, which requires the power amplifier to have plural output terminals. FIG. 2 is a block diagram showing an example of a configuration of a portion from the output terminal to the antenna of the RF power amplifier, in the sending portion of a wireless terminal compatible with seven bands: GSM850, E-GSM900, DCS1800, PCS1900, UMTS Band-V, UMTS Band-I, and UMTS Band-IX. UMTS requires a duplexer (DUP) for each band, and GSM/DCS/PCS require a low-pass filter (LPF) for each frequency band; thus, it is necessary to provide five output terminals with the RF power amplifier to deal with these seven bands. The conventional configuration shown in FIG. 12 cannot realize switching of three or more paths and is therefore not compatible with multiple bands and multiple modes; whereas the RF power amplifier A is compatible with multiple bands and multiple modes by increasing the number of the switch output terminals of the first switch 109 and the switch output terminals of the second switch 110.

Note that the two cases where the RF power amplifier A operates at one band of the first frequency range and operating at two bands of the second frequency range have been described above, but it is sufficient that each of the first and the second frequency ranges includes at least one band, that is, a frequency range in accordance with the communication system. For example, in each of the first and the second frequency ranges, the RF power amplifier A may deal with more bands and modes.

### Variation of First Embodiment

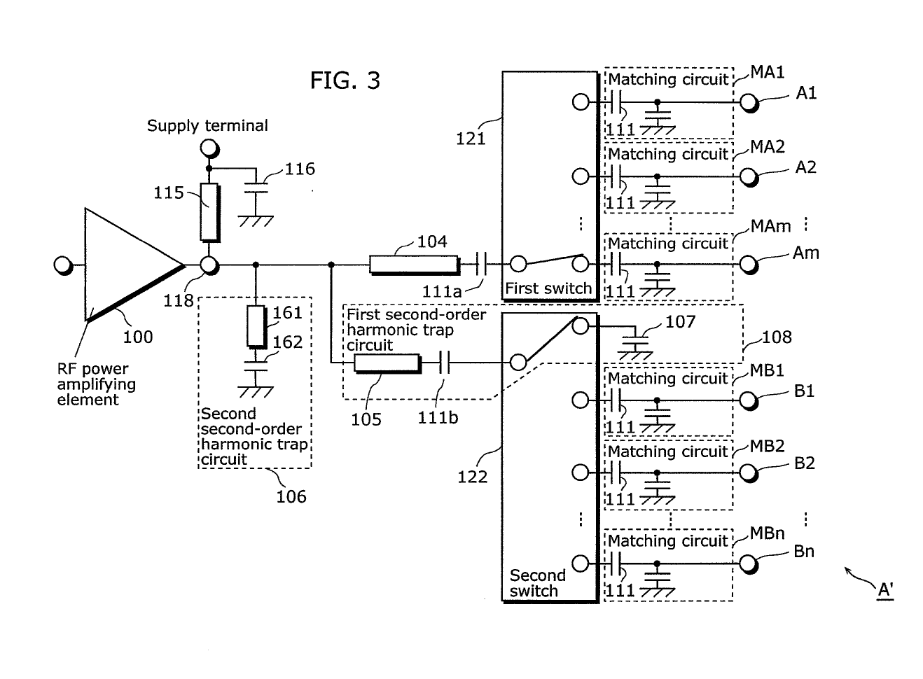

FIG. 3 is a diagram showing a schematic view of a circuit configuration when extended to be multiband and multimode.

Compared to the RF power amplifier A shown in FIG. 1, for the RF power amplifier A′ shown in the figure, each of the first and the second frequency ranges includes plural bands. Accordingly, the RF power amplifier A′ includes: amplifier output terminals A1 to Am (m is an integer equal to or larger than 2) corresponding to respective bands of the first frequency range; amplifier output terminals B1 to Bn (n is an integer equal to or larger than 2) corresponding to respective bands of the second frequency range; matching circuits MA1 to MAm corresponding to the respective bands of the first frequency range; and matching circuits MB1 to MBn corresponding to the respective bands of the second frequency range. In addition, the RF power amplifier A′ includes, in place of the first switch 109, a first switch 121 having a switch output terminal corresponding to each of the matching circuits MA1 to MAm. In addition, the RF power amplifier A′ includes, in place of the second switch 110, a second switch 122 having a switch output terminal corresponding to each of the matching circuits MB1 to MBn. The following description will be focused on the differences from the first embodiment.

The first second-order harmonic trap circuit 108 is realized by electrically connecting the transmission line 105 and the grounded capacitor 107 via the second switch 122 when the switch input terminal and the switch output terminal connected to the grounded capacitor 107 are connected. Specifically, the resonance frequency of the first second-order harmonic trap circuit 108 is set to a value which can sufficiently suppress the second-order harmonic signal of the first frequency range that is used.

The resonance frequency of the second second-order harmonic trap circuit 106 is set to a value which can sufficiently suppress the second-order harmonic signal of the second frequency range that is used.

The first switch 121 is a switch including one switch input terminal and m switch output terminals, and selectively connects the switch input terminal and one of the m switch output terminals, or does not connect the switch input terminal to any of the m switch output terminals. The switch input terminal is electrically connected to the transmission line 104, and each of the switch output terminals is connected to a corresponding one of the amplifier output terminals A1 to Am via one of the matching circuits MA1 to MAm.

The second switch 122 is a switch including one switch input terminal and n+1 switch output terminals, and selectively connects the switch input terminal and one of the n+1 switch output terminals. The switch input terminal is electrically connected to the transmission line 105, and each of the n+1 switch output terminals is connected to a corresponding one of the amplifier output terminals B1 to Bn via the grounded capacitor 107 or one of the matching circuits MB1 to MBn. Note that each of the matching circuits MA1 to MAm and MB1 to MBn has a DC-cutting capacitor 111 between a corresponding one of the switch output terminals and a corresponding one of the amplifier output terminals A1 to Am and B1 to Bn that are connected to each of the matching circuits.

The following will describe an operation of the RF power amplifier A′ having a configuration as above.

When the RF power amplifier A′ operates at one of the bands of the second frequency range, the switch input terminal of the first switch 121 turns off. In other words, the switch input terminal is disconnected from all the switch output terminals. In addition, the second switch 122 connects the switch input terminal and the switch output terminal connected to one of the matching circuit MB1 to MBn that corresponds to the operating band.

Thus, when the RF power amplifier A′ operates at one of the bands of the second frequency range, the frequency signal output from the output terminal 118 of the RF power amplifying element 100, with the second-order harmonic sufficiently suppressed by the second second-order harmonic trap circuit 106, is transmitted via the transmission line 105 and the second switch 122. Then, the frequency signal is output to the corresponding one of the amplifier output terminals B1 to Bn, via one of the matching circuits MB1 to MBn that is connected with the second switch 122 and corresponds to the operating band.

On the other hand, when the RF power amplifier A′ operates at one of the bands of the first frequency range, the first switch 121 connects the switch input terminal with the switch output terminal connected to one of the matching circuits MB1 to MBn that corresponds to the operating band. The second switch 122 connects the switch input terminal with the switch output terminal connected to the grounded capacitor 107.

Thus, when the RF power amplifier A′ operates at one of the bands of the first frequency range, the frequency signal output from the output terminal 118 of the RF power amplifying element 100 is transmitted via the transmission line 104 and the first switch 121, with the second-order harmonic sufficiently suppressed by the first second-order harmonic trap circuit 108. Then, the frequency signal is output to the corresponding one of the amplifier output terminals A1 to Am, via one of the matching circuits MA1 to MAm that is connected with the first switch and corresponds to the operating band. In other words, this disconnects the switch input terminal from all the switch output terminals that are electrically connected to the amplifier output terminals A1 to Am and B1 to Bn except one of the amplifier output terminals A1 to Am and B1 to Bn that corresponds to the operating band, thus sufficiently suppressing signals output from the amplifier output terminals A1 to Am and B1 to Bn except a signal output from the one of the amplifier output terminals A1 to Am and B1 to Bn that corresponds to the operating band.

As described above, the RF power amplifier A′ according to this variation can further increase compatibility with multiple bands and multiple modes.

### Second Embodiment

An RF power amplifier according to a second embodiment differs from the RF power amplifier A according to the first embodiment in that the RF power amplifier according to the second embodiment further includes a capacitor having one end electrically connected to a second RF transmission line and the other end grounded. This allows the RF power amplifier according to the present embodiment to be more compact and more efficient than the RF power amplifier A according to the first embodiment. The following description will be focused on the difference from the first embodiment.

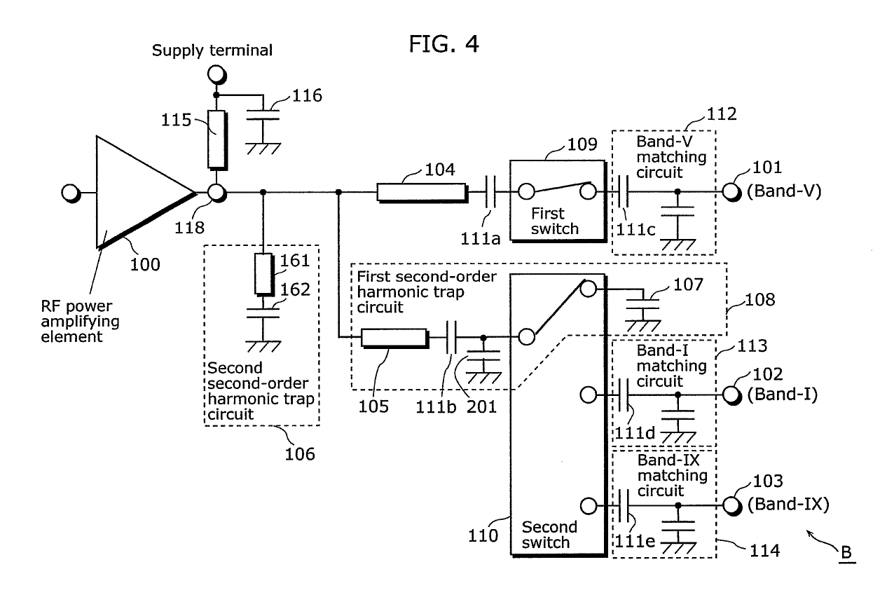

FIG. 4 is a diagram showing a schematic view of a circuit configuration of an RF power amplifier according to the second embodiment. Compared to the RF power amplifier A shown in FIG. 1, the RF power amplifier B shown in FIG. 4 includes a grounded capacitor 201 having one end connected to the transmission line 105 via the DC-cutting capacitor 111b and the other end grounded. In addition, the first second-order harmonic trap circuit 108 includes this grounded capacitor 201.

With this, when the RF power amplifier B operates in the first frequency range, the capacitance value necessary for configuring the first second-order harmonic trap circuit 108 is realized as synthesized capacitance using the grounded capacitor 201 and the grounded capacitor 107. Thus, in the present embodiment, the capacitance value of the grounded capacitor 107 can be smaller than in the first embodiment. Furthermore, in the first second-order harmonic trap circuit 108 in the present embodiment, the grounded capacitor 201, which functions as part of the synthesized capacitor, is grounded without involving the second switch 110, thus allowing reducing loss in the first second-order harmonic trap circuit 108 further than in the first embodiment.

In addition, when the RF power amplifier B operates in the second frequency range, since the grounded capacitor 201 is part of a matching circuit, it is possible to downsize the Band-I matching circuit 113 and the Band-IX matching circuit 114.

As described above, in the present embodiment, it is possible to provide the RF power amplifier B which is more compact and more efficient than in the first embodiment.

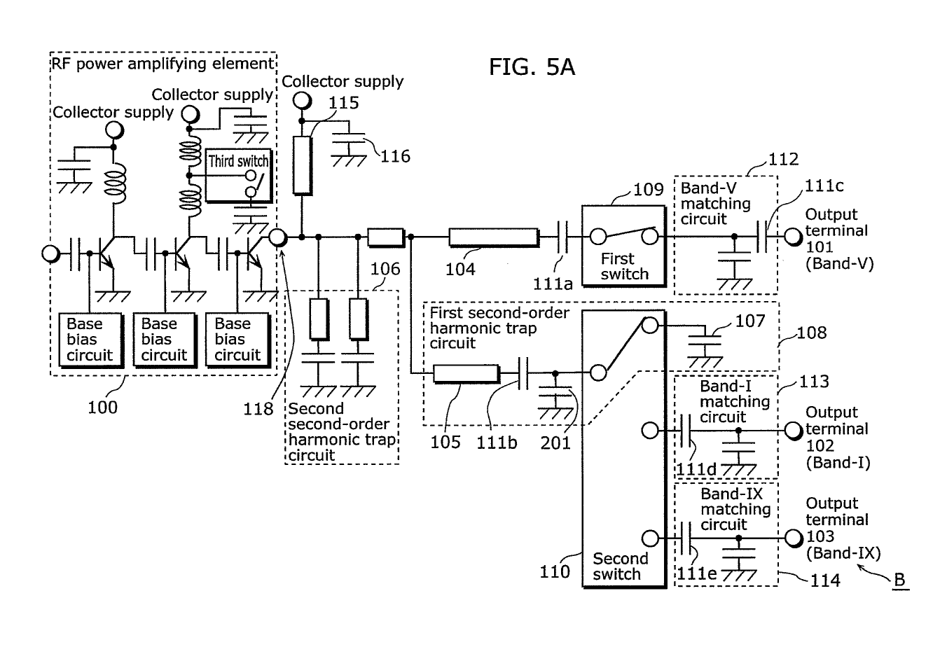

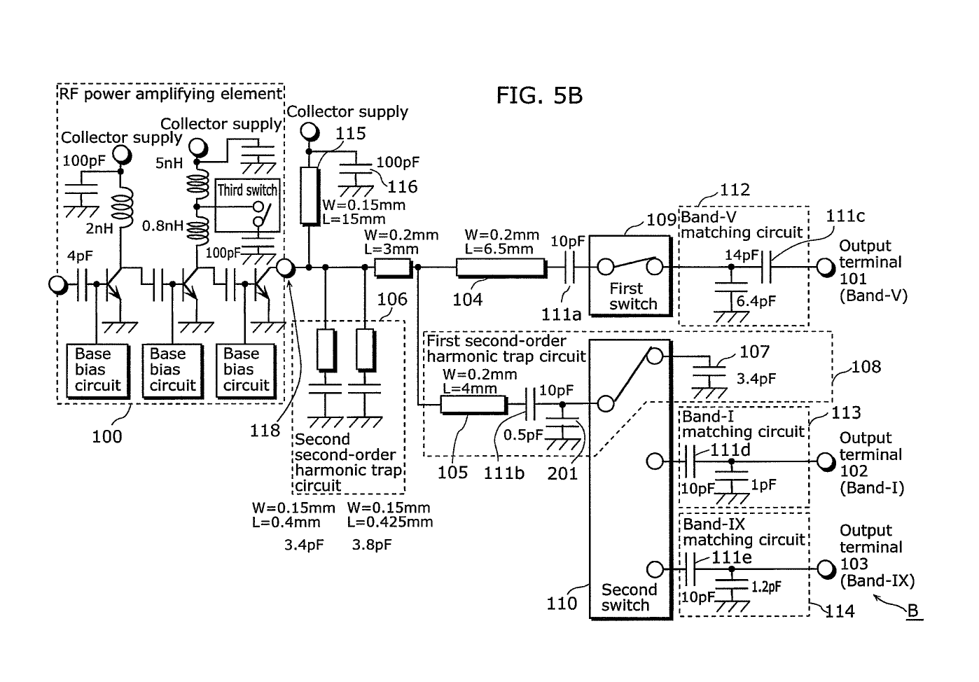

Next, an advantageous effect of the present invention will be described using a simulation result. FIG. 5A is a diagram showing a specific circuit configuration used for the simulation, and FIG. 5B is a diagram showing a simulation condition in the circuit configuration.

As shown in FIG. 5A, the RF power amplifying element 100 is a three-stage amplifier using a hetero bipolar transistor including GaAs, and includes an input matching circuit, an interstage matching circuit between the stages, and an output matching circuit. The transistor in each of the front, middle, and back stages has a base connected to a base bias circuit, a collector connected to a collector supply, and an emitter grounded. Between the collector of the transistor and the collector supply in each stage, a bypass capacitor for removing unnecessary signals and a bias line or inductor are connected.

Specifically, between the collector supply and the collector of a middle-stage transistor, two inductors having an inductance value of 5 nH and 0.8 nH are connected in series, a grounded capacitor is connected in between the two inductors via a third switch, and a grounded capacitor is also connected in between the inductors and the collector supply of the middle-stage transistor.

The RF power amplifying element 100 shown in FIGS. 5A and 5B switches transmission characteristics of the RF power amplifier B by turning off the third switch when operating in the first frequency range, and turning on the third switch when operating in the second frequency range. Specifically, the third switch is turned off in the case of operating in the first frequency range, so that the inductance value between the middle-stage collector and the grounded capacitor is 5.8 nH. Specifically, the third switch is turned on when operating in the second frequency range, so that the inductance value between the middle-stage collector and the grounded capacitor is 0.8 nH. With this, a matching circuit is formed to have the inductor connected to the collector of the middle-stage transistor, the grounded capacitor, and the series capacitor connected in between the inductor connected to the collector of the middle-stage transistor and the base of the back-stage transistor, thus allowing a signal of a desired operating frequency range to be transmitted to a back-stage transistor. Note that the above configuration has been used for the simulation condition, but any configuration may be used as long as it allows transmission of a signal of the desired operating frequency range to the back-stage transistor.

The first switch 109 and the second switch 110 are switches using a field-effect transistor including GaAs, and in the simulation, a series resistor of 2.1Ω is inserted into an on-path and a series capacitor of 0.5 pF is inserted into an off-path as equivalent circuits.

The second second-order harmonic trap circuit 106 has a configuration in which two serial resonance circuits having different resonances are connected so as to sufficiently suppress the second-order harmonic of the Band-IX and Band-I. The serial resonance circuits each include a transmission line and a grounded capacitor having one end connected to the transmission line and the other end grounded.

The following are simulation results of insertion loss and gain of the RF power amplifier on the simulation condition shown in FIG. 5B. First, the result of the simulation of insertion loss will be described.

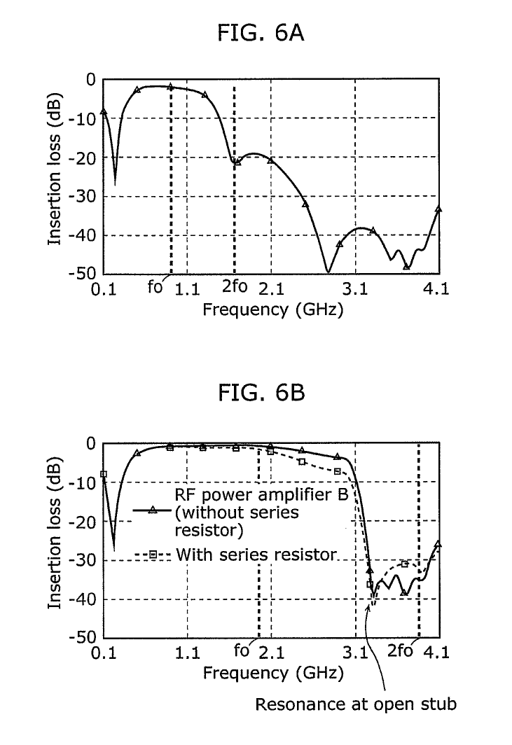

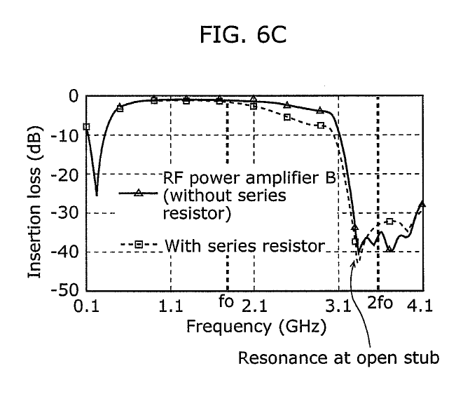

FIG. 6A is a graph showing an insertion loss in the load matching circuit when the RF power amplifier B according to the present embodiment operates at Band-V. Note that the insertion loss is hereafter described in absolute value.

The simulation shown in the figure has resulted in an insertion loss of 1.75 dB or less in a range of 824 MHz to 849 MHz which is the usable frequency range of Band-V, and an insertion loss of 20 dB or more in a range of 1648 MHz to 1698 MHz which is the second-order harmonic of Band-V. Thus, it is possible to achieve a small insertion loss in the usable frequency range and to sufficiently attenuate the harmonic. Note that in the case of operation at Band-V, the second second-order harmonic trap circuit 106 is connected, but the resonance frequency thereof is 3.5 GHz or more, thus achieving a sufficiently small insertion loss in the usable frequency range.

FIG. 6B is a graph showing an insertion loss of a load matching circuit when the RF power amplifier B according to the present embodiment operates at Band-I. Note that the figure also shows an insertion loss generated in the case of inserting, between the second second-order harmonic trap circuit 106 and the output terminal 118 shown in FIG. 5A, a series resistor of 2.1Ω which is a resistor corresponding to the case of inserting a switch into the second-order harmonic trap circuit in conventional technique.

The simulation shown in the figure has resulted in an insertion loss of 0.8 dB or less for the RF power amplifier B, in a range of 1920 MHz to 1980 MHz which is the usable frequency range of Band-I, and an insertion loss of 1.8 dB or more in the case corresponding to the conventional technique where the series resistor is provided. Thus, the insertion loss is improved (smaller) by 1 dB or more compared to the conventional case. In addition, in a range of 3840 MHz to 3960 MHz which is the second-order harmonic of Band-I, an insertion loss for the RF power amplifier B is 30 dB or more, thus achieving sufficient attenuation of the harmonic. Note that in the frequency range of the second-order harmonic, the insertion loss is improved (larger) by approximately 3 dB as compared to the case of the case corresponding to the conventional technique, thus allowing further suppression of the harmonic.

FIG. 6C is a graph showing an insertion loss in the load matching circuit when the RF power amplifier B according to the present embodiment operates at Band-IX. Note that the figure also shows, as FIG. 6B, an insertion loss generated in the case of inserting, between the second second-order harmonic trap circuit 106 and the output terminal 118 shown in FIG. 5A, a series resistor of 2.1Ω which is a resistor corresponding to the case of inserting a switch into the second-order harmonic trap circuit in the conventional technique.

The simulation shown in the figure has resulted in an insertion loss of 0.8 dB or less in a range of 1749.9 MHz to 1784.9 MHz which is the usable frequency range of Band-I, and an insertion loss of 1.4 dB in the case corresponding to conventional technique where the series resistor is provided. Thus, the insertion loss is improved (smaller) by 0.6 dB or more compared to the conventional case. In addition, in a range of 3499.8 MHz to 3569.8 MHz which is the second-order harmonic of Band-IX, an insertion loss for the RF power amplifier B is 30 dB or more, thus achieving sufficient attenuation of the harmonic. Note that in the frequency band of the second-order harmonic, the insertion loss is improved (larger) by approximately 3 dB as compared to the case corresponding to conventional technique, thus allowing further suppression of the harmonic.

Note that when the RF power amplifier B operates at Band-I and Band-IX, the transmission line, which is inserted between the RF power amplifying element 100 and the first switch 109, functions as an open stub, but the resonance frequency thereof is approximately 3.3 GHz, achieving a sufficiently small insertion loss in the usable frequency range.

As described above, the RF power amplifier B according to the present embodiment can suppress insertion loss in the usable frequency range. Thus, the RF power amplifier B achieves high efficiency in the usable frequency range. Note that this simulation has been conducted with the RF power amplifier B according to the second embodiment, but the RF power amplifier A according to the first embodiment, which also includes the second second-order harmonic trap circuit, can likewise suppress insertion loss and achieves high efficiency.

Next, a simulation result of a small-signal gain of the RF power amplifier B is shown.

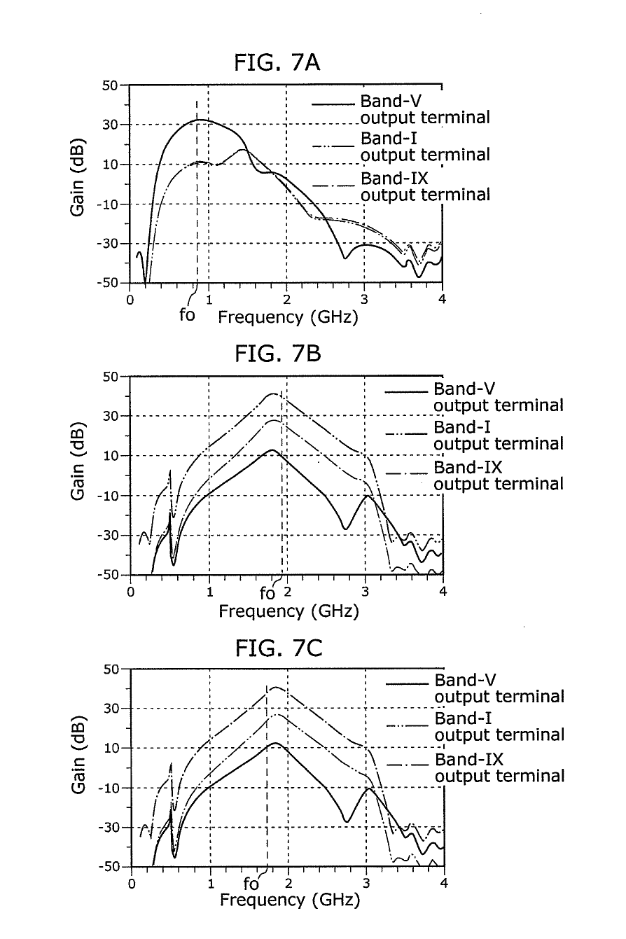

FIG. 7A is a graph showing a gain, in the RF power amplifier B, of an electric power output from the Band-V amplifier output terminal 101, the Band-I amplifier output terminal 102, and the Band-IX amplifier output terminal 103, with respect to the input power to the RF power amplifier B. The input power to the RF power amplifier B is an input power to the RF power amplifying element 100. Likewise, FIG. 7B shows a graph showing a gain at the time of operating at Band-I, and FIG. 7C is a graph showing a gain at the time of operating at Band-IX.

When operating at Band-V as shown in FIG. 7A, a power leakage into each of the Band-I amplifier output terminal 102 and the Band-IX amplifier output terminal 103 is attenuated by 20 dB or more with respect to the power output to the Band-V amplifier output terminal 101; thus, sufficient isolation between the amplifier output terminals is secured.

When operating at Band-I as shown in FIG. 7B, a power leakage into the Band-V amplifier output terminal 101 is attenuated by 28 dB or more with respect to the power output to the Band-V amplifier output terminal 101; thus, sufficient isolation between the amplifier output terminals is secured. In addition, a power leakage into the Band-IX amplifier output terminal 103 is attenuated by 10 dB or more with respect to the power output to the Band-I amplifier output terminal 102; thus, sufficient isolation between the amplifier output terminals is secured.

When operating at Band-I as shown in FIG. 7C, a power leakage into the Band-V amplifier output terminal 101 is attenuated by 28 dB or more with respect to the power output to the Band-IX amplifier output terminal 101; thus, sufficient isolation between the amplifier output terminals is secured. In addition, a power leakage into Band-I amplifier output terminal 102 is attenuated by 10 dB or more with respect to the power output to Band-I amplifier output terminal 103; thus, sufficient isolation between the amplifier output terminals is secured.

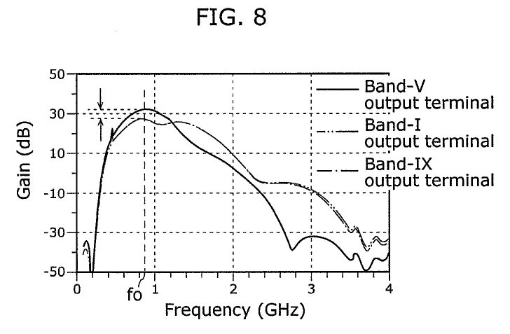

FIG. 8 is a graph showing, as a reference example of isolation between amplifier output terminals as represented by the conventional technique, a simulation result of the small-signal gain at the time of operating at Band-V, in the case of a configuration which does not include a series switch, that is, the second switch 110 in the path for the second frequency range. Note that the condition above has been realized, in the configuration shown in FIG. 5B, by inserting, into an equivalent circuit, a resistance of 0Ω instead of the series capacitance of 0.5 pF inserted into the off-path in each of the following paths: the path which is located between the switch input terminal of the second switch 110 and the Band-I amplifier output terminal 102 and which turns off when operating at Band-V; and the path between the switch input terminal of the second switch 110 and the Band-IX amplifier output terminal 103.

As the simulation result in FIG. 8 shows, since the referential configuration as represented by the conventional technique does not include a switch which blocks signals in the output path for the second frequency range, the power output from each of the Band-I amplifier output terminal 102 and the Band-IX amplifier output terminal 103 is attenuated only by 4 dB or so compared to the power output from the Band-V amplifier output terminal 101; thus, it is not possible to sufficiently secure isolation between the amplifier output terminals.

As described above, the RF power amplifier B according to the present embodiment can sufficiently secure isolation between the amplifier output terminals by including the second switch 110 provided in the transmission path of the RF signal in series, in the path for the second frequency range, that is, in the second transmission unit. Note that this simulation has been conducted with the RF power amplifier B according to the second embodiment, but the RF power amplifier A according to the first embodiment, which also includes the second second-order harmonic trap circuit, can likewise secure sufficient isolation between the amplifier output terminals.

In addition, by providing the transmission line 104 longer than the transmission line 105, an inductance component from the output terminal 118 of the RF power amplifying element 100 to the input terminal of the first switch 109 is larger than an inductance component from the output terminal 118 of the RF power amplifying element 100 to the switch input terminal of the second switch 110. This allows part of the first second-order harmonic trap circuit 108 and the path for the second frequency range to be shared, thus allowing downsizing of the load matching circuit.

Thus far, the RF power amplifier according to the present invention has been described according to the embodiments and the variation, but the present invention is not limited to these embodiments and variation. Those skilled in the art will readily appreciate that many modifications are possible in the exemplary embodiments without departing from the novel teachings and advantages of this invention. Accordingly, all such modifications are intended to be included within the scope of this invention.

For example, the above embodiments have assumed the first frequency range to be UMTS Band-V, and the second frequency range to be UMTS Band-I and Band-IX, but the present invention is not limited to these.

The following are representative examples to which the present invention is applicable. When assuming that the first frequency range is 824 MHz to 915 MHz and the second frequency range is 1710 MHz to 1980 MHz, exemplary communication standards using the first frequency range are GSM850, E-GSM900, UMTS Band-V, UMTS Band-VI, and UMTS Band-VIII, and exemplary communication standards using the second frequency range are DCS1800, PCS1900, UMTS Band-I, UMTS Band-II, UMTS Band-III, UMTS Band-IV, UMTS Band-IX, UMTS Band-X, PHS, and so on.

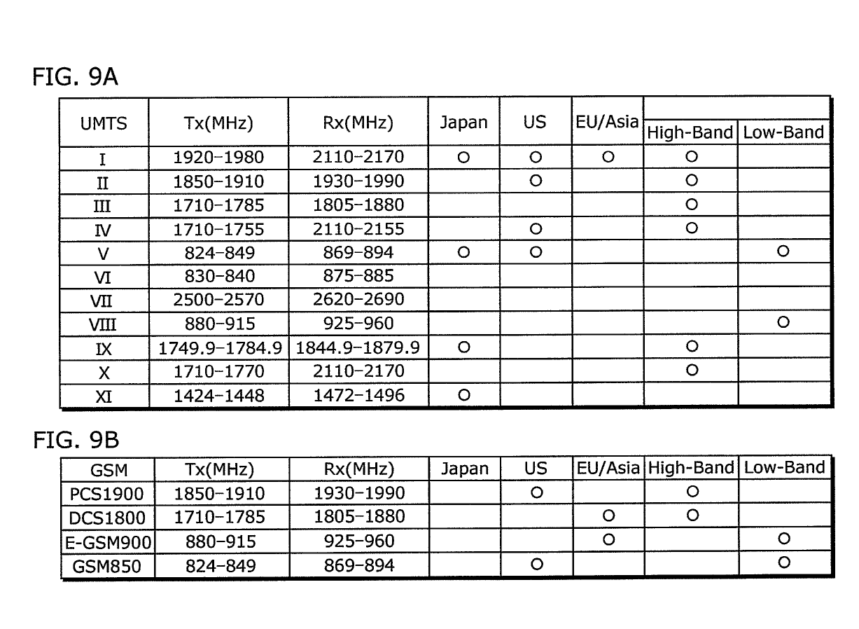

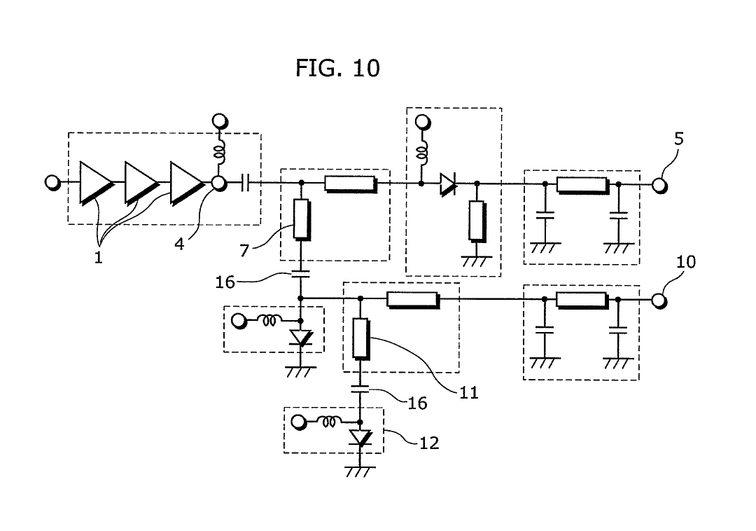

In addition, when assuming that the first frequency range is 2.4 GHz to 2.5 GHz and the second frequency range is 5 GHz, exemplary communication standards using the frequency band of the first frequency range are Bluetooth, a wireless LAN of 2.4 GHz bandwidth, and the mobile WiMAX and the next-generation PHS that are scheduled to be launched in 2009, and so on, and exemplary communication standards using the second frequency range is a wireless LAN of 5 GHz bandwidth, and so on. It is also possible to apply the present invention to a case other than the examples described above, on condition that the second-order harmonic trap circuit for the second frequency range does not influence the matching of the first frequency range and that the transmission path 15 for the first frequency range does not influence the matching of the second frequency range. FIGS. 9A and 9B show usable frequency ranges according to the communication standards.

In addition, in all the embodiments described above, the RF power amplifying element 100 includes a hetero bipolar transistor including GaAs, but may include another transistor such as: a bipolar transistor, a silicon-germanium transistor, a field-effect transistor, and an insulated gate bipolar transistor (IGBT). Furthermore, such transistors may be included in respective stages as a single transistor or plural transistors. Furthermore, each stage may have a multistage configuration. When including these transistors to configure an RF power amplifier, an emitter ground or a source ground is used. In this case, the input side is a base terminal or gate terminal, and the output terminal 118 is a collector terminal or drain terminal, and the common terminal is an emitter terminal or source terminal.

In addition, the first switch 109 and the second switch 110 each include the field-effect transistor including GaAs, but a field-effect transistor including GaN, CMOS, and so on, a PIN diode switch, a MEMS switch, and so on may be used.

In addition, the second second-order harmonic trap circuit 106 need not have the configuration described above as long as the configuration does not include a switch element or a resistor.

Thus far the embodiments have been described as mere examples to specifically describe the invention, and therefore the present invention is not limited to these examples and can thus be developed into various examples that are easily configurable by those skilled in the art using the techniques disclosed in the present invention.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to an RF power amplifier of multiband compatibility used for a mobile communication device and so on.

What is claimed is:

1. A radio frequency power amplifier comprising:
an amplifying element which amplifies a first radio frequency signal and a second radio frequency signal having a frequency higher than a frequency of the first radio frequency signal;
a first transmission unit configured to transmit the first radio frequency signal output by said amplifying element;
a second transmission unit configured to transmit the second radio frequency signal output by said amplifying element; and
a second radio frequency signal trap circuit which is connected to an output terminal of said amplifying element and suppresses a harmonic signal of the second radio frequency signal amplified by said amplifying element,
wherein said first transmission unit includes:
a first transmission path through which the first radio frequency signal output by said amplifying element is transmitted; and
a switch element which is provided in said first transmission path, and which turns on when said amplifying element amplifies the first radio frequency signal, and turns off when said amplifying element amplifies the second radio frequency signal, and
said second transmission unit includes:
an impedance circuit which suppresses a harmonic signal of the first radio frequency signal;
a second transmission path through which the first radio frequency signal and the second radio frequency signal output by said amplifying element are transmitted;
a third transmission path through which the second radio frequency signal is transmitted to an output terminal of said second transmission unit; and
a switch circuit which connects said second transmission path and said impedance circuit in series when said amplifying element amplifies the first radio frequency signal, and which connects said second transmission path and said third transmission path in series when said amplifying element amplifies the second radio frequency signal.

2. The radio frequency power amplifier according to claim 1,
wherein said second transmission path and said impedance circuit function as a first radio frequency signal trap circuit which suppresses the harmonic signal of the first radio frequency signal via said switch circuit, when said switch circuit connects said second transmission path and said impedance circuit.

3. The radio frequency power amplifier according to claim 2,
wherein said second transmission path includes a second radio frequency transmission line having one end connected to the output terminal of said amplifying element and the other end electrically connected to said switch circuit, and
said second transmission unit further includes a capacitor having one end electrically connected to said second radio frequency transmission line and the other end grounded.

4. The radio frequency power amplifier according to claim 3,
wherein said first transmission path includes a first radio frequency transmission line having one end connected to an output terminal of said amplifying element and the other end electrically connected to said switch circuit, and
an inductance component of said first transmission path is larger than inductance components of said second transmission path and said capacitor.

5. The radio frequency power amplifier according to claim 2,
wherein a resonance frequency of said first radio frequency signal trap circuit is within a frequency range that is double a frequency range of the first radio frequency signal, and
a resonance frequency of said second radio frequency signal trap circuit is within a frequency range that is double a frequency range of the second radio frequency signal.

6. The radio frequency power amplifier according to claim 1,
wherein a resonance frequency of said impedance circuit is within a frequency range that is double a frequency range of the first radio frequency signal, and
a resonance frequency of said second radio frequency signal trap circuit is within a frequency range that is double a frequency range of the second radio frequency signal.

7. The radio frequency power amplifier according to claim 1,
wherein each of frequency ranges of the first radio frequency signal and the second radio frequency signal includes a frequency band of at least one communication system.
